(19) United States
(12) Patent Application Publication
(10) Pub. No.: US 2013/0056150 A1
(43) Pub. Date: Mar. 7, 2013

(54) PROCESS FOR APPLYING RESIN ON THE SURFACE OF A MOULDING BASE TOOL, TREATED WITH MOULD-RELEASE SUBSTANCES, IN ORDER TO OBTAIN BODIES OF COMPOSITE MATERIAL

(71) Applicant: AIRBUS OPERATIONS, S.L., Getafe (ES)

(72) Inventors: Jose David Cano Cediel, Madrid (ES); Asuncion Carrascal Iglesias, Madrid (ES); Georgina Galera Cordoba, Madrid (ES)

(73) Assignee: AIRBUS OPERATIONS, S.L., Getafe (ES)

(21) Appl. No.: 13/665,564

(22) Filed: Oct. 31, 2012

Related U.S. Application Data
(63) Continuation of application No. PCT/ES2011/070286, filed on Apr. 20, 2011.

(30) Foreign Application Priority Data
Apr. 30, 2010 (ES) P201030644

(51) Int. Cl. B32B 37/00; B32B 38/16

(52) U.S. Cl. 156/281

(57) ABSTRACT

The invention comprises, a first preliminary step of cleaning the treatment surface of the moulding base tool and a second step in which the necessary layers of mould-release agent are applied to the treatment surface of the moulding base tool. Based on said preliminary steps, the process is characterized in that, in a later step, the treatment surface (1), covered with a mould-release agent (3), is provided with a continuous uniform film (4) of resin having a low concentration of volatile elements and a laminar resin supporting a very high mould-release capability, which facilitates the transfer of resin to the treatment surface (1) of the moulding base tool (2).

### OBJECT OF THE INVENTION

The present invention, as expressed in the statement of this specification, relates to a process for applying a film of resin on the surface of a moulding base tool, treated with mould-release substances, in order to obtain bodies of composite material, aimed at increasing the degree of adherence on treated surfaces in order to favour the positioning of the layers of any pre-impregnated material, such as carbon fibre, glass, bronze mesh, expanded copper foiled, etc.

So, the object of the invention arises from the need to increase the adherence between the surface whereon the laminating is carried out and the pre-impregnated material to be placed on said surface.

The invention is applicable to the manufacturing of pieces of composite material in which one of their components is in a cured state (basic elements) and other or others are in a fresh state (stiffening elements), whenever the bond is made between them. These pieces can be any one belonging to the following elements:
Aircraft structures and aircraft controls (such as support surface coatings, stringers, ribs, fittings).
Spaceships.
Marine and land vehicles.
Industrial machinery and equipment.

The manufacturing processes implicated are the following:
Lamination of the composite material (manual or automatic).
Cutting said composite material.
Hot-molding of the composite material.
Handling and positioning of the pieces and tools.
Curing in autoclave.

The materials used can be composed of different resins and different fibre types, such as:
Glass fibre.
Carbon fibre.
Kevlar.
Boron fibre.
Epoxy resin.
Thermoplastic resin.
Other thermo-stable resins.

### BACKGROUND OF THE INVENTION

The manufacturing of structures made up of composite materials is broadly consolidated in the aeronautics industry, said structures present an optimal relationship between mechanical properties (resistance and stiffness) and weight.

The increasingly extended use of composite materials in primary structures is a consequence of this requirement, since, by applying the aforementioned composite materials in a convenient manner, important savings in weight can be achieved compared to a metallic material-based design.

Another advantage of the use of composite materials is that, due to their condition of having independent layers that can be piled in the desired shape and orientation, they offer the possibility of a greater structure integration, often entails cost savings, which is also essential when competing in the market by having less individual pieces to assemble.

The lamination process of these composite material layers is usually carried out on a moulding tool, which must be treated with a mould-release element (silicone particles solution leaving a fine film with highly anti-adherent properties after the evaporation of the solvent element) so that, after the laminate has been cured, said laminate can be separated from the aforementioned moulding tool. If the moulding tool was left untreated, the laminate would be permanently stuck to the aforementioned moulding tool.

Due to the need to obtain an adherent surface in order to facilitate the positioning of the first layer of composite material to be laminated on the tool, there is a classic solution used in the industry. Said solution consists of applying a resin solution with a high content of volatile materials after the mould-release layer. However, with the entry into the market of water-based mould-release agents, which improve working conditions in terms of security and hygiene, it should be noted that this method is ineffective and counterproductive. It is ineffective because the resin is not uniformly distributed due to precipitation and the formation of clusters of materials, and it is counterproductive because the use of solvents for the application of the resin is not justifiable since said solvents are being eliminated from the mould-release agent formulation.

On the other hand, until now and because of the priority use of solvent-based mould-release agents, the increase in adherence is achieved by means of the manual application of a resin solution due to the priority use of solvent-based mould-release agents.

However, nowadays water-based mould-release agents have started to prevail. Said water-based mould-release agents have the advantage of being much less polluting for the environment by dispensing with solvents in their composition; this is the reason behind their quick application in an industry with stricter regulations.

From a technical standpoint and with the new solvents, the application of the resin in the traditional format and manner is impossible: Said impossibility is the reason why the development of new techniques and processes, such as the object of the invention which allows the uniform application of a layer of resin without using solvents for its application, has become necessary.

### DESCRIPTION OF THE INVENTION

With the purpose of achieving the objectives and avoiding the inconveniences mentioned in the previous sections, the invention discloses a resin application process on a surface treated with mould-release substances on a moulding base tool in order to obtain bodies of composite material, characterized in that a continuous and uniform film of resin is applied on the surface treated with mould-release substances of a moulding base tool. Said layer of resin is preferably applied automatically by means of the machine used for laminating, or manually with the help of a roller or any other element that allows pressing and sliding at the same time.

This way, the adherence to the moulding base tool previously treated with a mould-release agent essentially water-based, is improved.

The resin application process begins with a conventional preliminary cleaning step of the surface on which the resin is to be applied and the prior application of the corresponding mould-release agent.

Afterwards, during a subsequent main step, the film of resin having a very low content of volatile elements with a laminar resin supporting a very high mould-release capability is provided in order to facilitate the transfer of the resin to the surface treated with the mould-release agent of the moulding base tool.

Lastly, once the resin layer is applied on the entire surface of the moulding base tool covered by the mould-release agent, any composite material can be laminated onto the resin layer in optimal adherence conditions.

The advantages of the application process of the film of resin are the following:
Feasibility of laminating on tools treated with water-based mould-release agents, regardless of the complexity of the geometry.
The process can be carried out in a clean room (a space whose temperature and humidity have been adjusted and is free from polluting particles), thus eliminating the risk of pollution of the moulding base tool.
A specially commissioned space or a specific device for the application of resin are not needed, since said application is carried out, in principle, on the automatic taping machine, thus also eliminating the time and means used to transport the tool between the resin application station and the automatic taping station.
High quality of the adherent layer applied, which is uniform and continuous and maintains its thickness.
The process is clean and reliable.

The moulding base tool can be preferably manufactured in pre-cured carbon fibre or glass fibre, as well as in nylon-type plastics or necuron.

Next, in order to facilitate a better understanding of this specification and forming an integral part thereof, a set of figures showing the object of the invention in an illustrative rather than limitative manner, accompany this specification.

### BRIEF DESCRIPTION OF THE DRAWINGS

FIG. 1 shows a schematic exploded view of the resin application process on a surface treated with mould-release substances of a moulding base tool in order to obtain bodies of composite material. The process of the invention essentially comprises the application of a continuous uniform film of resin on the surface of the moulding base tool previously treated with the corresponding mould-release substances.

FIG. 2 represents a schematic view of a process where it is essentially showed a head of a conventional automatic laminating machine used to apply the continuous uniform film of resin also.

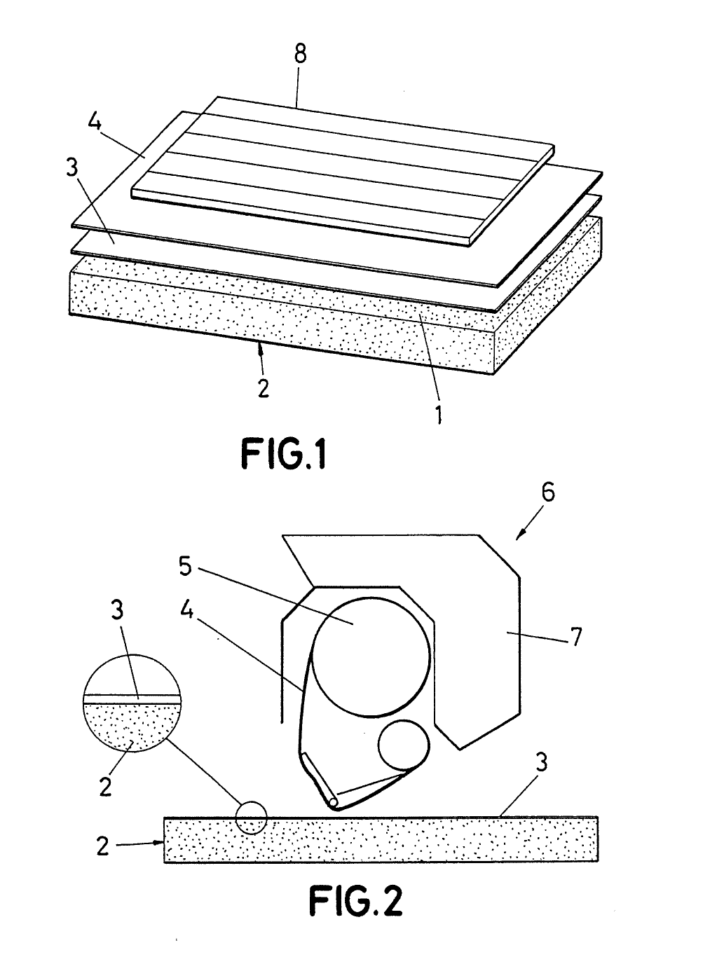

### DESCRIPTION OF THE PREFERRED EMBODIMENT

Taking into account the reference numbers of the figures, process for applying a film of resin on the surface of a moulding base tool, treated with mould-release substances in order to obtain bodies of composite material comprises the following steps:
A step beginning with the cleaning of a treatment surface 1 of the moulding base tool 2 by means of conventional sanding, laser cleaning or otherwise.
A second step in which the necessary layers of mould-release agent 3 are applied according to the procedure indicated by the manufacturer of the product, letting the product be cured for as long as necessary.
A third step in which a continuous uniform film of resin 4, with a low concentration of volatile elements (less than 2%) and whose support will be a paper with a very high mould-release capacity to facilitate the transfer of the resin to the moulding base tool 2, is supplied. The material is presented wound around an appropriate cylinder 5, with the format required by the machine to be used.
A fourth step in which the material is loaded into a head 7 of a conventional automatic tape laying machine 6, which is the machine 6 used for the taping of the impregnated materials; with said machine 6 additional devices in the manufacturing process are not required.
A fifth step in which the head 7 of the machine 6 is displaced along the entire surface of the tool to be prepared, applying the appropriate pressure, advance speed and temperature parameters in order to allow the transfer of the film of resin 4 from the support paper to the tool being prepared.
A last step in which any composite material will be in the condition to be taped in optimal adherence conditions once the previous steps have been carried out.

On the other hand, the application of the film of resin 4 can also be made manually with the help of a roller or any other element that allows exerting pressure and sliding at the same time.

It should also be noted that the resin application process of the invention increases the adherence of the moulding tool, which allows the taping of the composite material layers of pre-impregnated carbon fibre. In addition, the process is extensible to any pre-impregnated composite material with any type of resin and is also applicable to any surface treated with mould-release elements, both water-based and solvent-based.

1. Process for applying resin on the surface of a moulding base tool, treated with mould-release substances, in order to obtain bodies of composite material, said process comprises:
a first preliminary step of cleaning the treatment surface of the moulding base tool;
a second preliminary step in which the mould-release agent on said treatment surface is applied;
being said process characterized in that:
in a later step, the treatment surface 1, which has been covered with a mould-release agent 3, is provided with a continuous uniform film layer 4 of resin having a low concentration of volatile elements and with a laminar resin supporting a very high mould-release capability.

2. Process for applying resin on the surface of a moulding base tool, treated with mould-release substances, in order to obtain bodies of composite material according to claim 1, characterized in that the application of the film 4 of resin is carried out by means of a conventional automatic tape laying machine 6, so that the film 4 of resin is presented as wound around a cylinder 5 coupled to a head 7 of the aforementioned machine 6.

3. Process for applying resin on the surface of a moulding base tool, treated with mould-release substances, in order to obtain bodies of composite material according to claim 1, characterized in that the application of the film 4 of resin is carried out manually with the help of a roller or any other element that allows pressing and sliding at the same time.

4. Process for applying resin on the surface of a moulding base tool, treated with mould-release substances, in order to obtain bodies of composite material according to any one of the previous claims, characterized in that the film 4 of resin comprises a low content of volatile elements below 2%:
